(19) United States
(12) Patent Application Publication
(10) Pub. No.: US 2016/0016354 A1
(43) Pub. Date: Jan. 21, 2016

(54) MOLD, IMPRINT APPARATUS, AND ARTICLE MANUFACTURING METHOD

(71) Applicant: CANON KABUSHIKI KAISHA, Tokyo (JP)

(72) Inventors: Eiji Sakamoto, Utsunomiya-shi (JP); Yusuke Tanaka, Tokyo (JP)

(21) Appl. No.: 14/798,659

(22) Filed: Jul. 14, 2015

(30) Foreign Application Priority Data
Jul. 16, 2014 (JP) 2014-146294

(51) Int. Cl. B29C 59/02

(52) U.S. Cl. CPC B29C 59/02; B29L 2007/001

(57) ABSTRACT

A mold includes a plurality of pattern regions, each having two sides parallel to a first direction and two sides parallel to a second direction. The plurality of pattern regions are located so that, for each of the plurality of pattern regions, the other pattern regions are present in regions of the mold aside from a first region sandwiched between two straight lines formed by extending the two sides parallel to the first direction in the first direction and a second region sandwiched between two straight lines formed by extending the two sides parallel to the second direction in the second direction.

### BACKGROUND OF THE INVENTION

1. Field of the Invention

The present invention relates to molds, imprint apparatuses, and article manufacturing methods.

2. Description of the Related Art

As demand increases for finer sizes in semiconductor devices, MEMS, and the like, a microfabrication technique in which a mold is pressed into uncured resin upon a substrate and a pattern formed in the mold is transferred onto the resin on the substrate is garnering attention, in addition to conventional photolithography techniques. This technique is called “imprinting”, and is capable of forming fine structures, to the order of tens of nanometers, on a substrate. The photo-curing method is an example of such an imprinting technique. An imprint apparatus that employs the photo-curing method first spreads a light curable resin onto a shot region serving as an imprint region on a substrate. The resin that has been spread is then shaped by pressing (stamping) the mold thereon. After the resin is irradiated with light and cured, the mold is pulled away from the substrate, thus forming a resin pattern on the substrate.

There are cases where a substrate subjected to an imprinting process expands or contracts during the series of device manufacture processes, for example due to undergoing a heating process during a deposition process such as sputtering, which causes the pattern to change shape in two axial directions orthogonal to each other within the substrate plane. However, when the imprint apparatus presses the mold into the resin on the substrate, it is necessary to align the shape of the imprint region (an underlying pattern) formed in advance on the substrate with the shape of the pattern formed in the mold. As a technique for aligning the shape of the deformed imprint region on the substrate side with the shape of the pattern region in the mold, Japanese Patent Laid-Open No. 2008-504141 discloses a correction mechanism that deforms and corrects the shape of the mold by applying an external force to the outer periphery of the mold.

As described above, the imprint process requires a plurality of processes, including a mold pressing process (mold contacting process). Methods that form patterns in a plurality of imprint regions formed on a substrate in a single imprint process by repeatedly forming patterns in individual imprint regions are problematic in that the process has a low throughput. In response, Japanese Patent Laid-Open No. 2012-204722 discloses an imprint apparatus capable of forming patterns in a plurality of imprint regions through a single imprint process by using a mold in which a plurality of pattern regions are formed. Meanwhile, Japanese Patent Laid-Open No. 2012-49370 discloses an imprint apparatus capable of forming patterns in a plurality of imprint regions through a single imprint process by using a plurality of molds.

FIGS. 9A to 9C illustrate a mold having a plurality of pattern regions, as disclosed in Japanese Patent Laid-Open No. 2012-204722. In a mold 8 illustrated in FIG. 9A, four pattern regions PA1 to PA4 are arranged in two rows and two columns. In the mold 8 illustrated in FIG. 9B, the four pattern regions PA1 to PA4 are arranged in a checkerboard pattern. In the mold 8 illustrated in FIG. 9C, five pattern regions PA1 to PA5 are arranged in the opposite checkerboard pattern from that illustrated in FIG. 9B. A correction mechanism for the shape of the mold 8 includes a first pressing member R that presses a side face of the mold 8 in an X direction and a second pressing member C that presses a side face of the mold 8 in a Y direction. Although only one each of the first pressing member R and the second pressing member C are illustrated as the correction mechanism in FIGS. 9A to 9C, the correction mechanism typically includes a plurality of first pressing members R and second pressing members C along side faces of the mold 8. As illustrated in FIG. 9A, when the first pressing member R is caused to act on the pattern region PA1 in order to correct the shape of the pattern region PA1, the first pressing member R ultimately also acts on the pattern region PA4, which does not need to be corrected. The same applies to the second pressing member C as well. Furthermore, the same applies to the molds 8 illustrated in FIGS. 9B and 9C. Accordingly, although the imprint apparatus disclosed in Japanese Patent Laid-Open No. 2012-204722 can achieve high throughput, there are cases where this imprint apparatus results in unfavorable overlaying of the patterns in the mold 8 on the patterns in the underlying regions of the substrate.

Meanwhile, although the imprint apparatus disclosed in Japanese Patent Laid-Open No. 2012-49370 can correct the shapes of molds individually, it is furthermore necessary to individually control the height positions of the plurality of molds as well. Accordingly, the imprint apparatus disclosed in Japanese Patent Laid-Open No. 2012-49370 has been problematic in that the configuration complicates and increases the size of the structure of an imprint head portion that contains the mold.

### SUMMARY OF THE INVENTION

The present invention provides a mold that is useful for overlaying the mold on an imprint region.

The present invention in its one aspect provides a mold capable of simultaneously forming a plurality of patterns of an imprint material on a substrate, the mold including: a plurality of pattern regions, each having two sides parallel to a first direction and two sides parallel to a second direction, wherein the plurality of pattern regions are located so that, for each of the plurality of pattern regions, the other pattern regions are present in regions of the mold aside from a first region sandwiched between two straight lines formed by extending the two sides parallel to the first direction in the first direction and a second region sandwiched between two straight lines formed by extending the two sides parallel to the second direction in the second direction.

Further features of the present invention will become apparent from the following description of exemplary embodiments (with reference to the attached drawings).

### BRIEF DESCRIPTION OF THE DRAWINGS

FIG. 1 is a diagram illustrating the configuration of an imprint apparatus according to the present invention.

FIG. 2 is a diagram illustrating primary components of the imprint apparatus according to the present invention.

FIG. 3 is a diagram illustrating the configuration of a mold according to a first embodiment.

FIG. 4 is a diagram illustrating a method for correcting the shape of a pattern region in a mold according to the present invention.

FIG. 5 is a diagram illustrating a substrate-side mark and a mold-side mark.

FIGS. 6A and 6B are diagrams illustrating examples of molds having a plurality of pattern regions according to the present invention.

FIGS. 7A to 7C are diagrams illustrating the configuration of a mold according to a second embodiment.

FIGS. 8A and 8B are diagrams illustrating corrected shapes of pattern regions in the molds according to the first embodiment and the second embodiment.

FIGS. 9A to 9C are diagrams illustrating molds having a plurality of pattern regions disclosed in related art.

### DESCRIPTION OF THE EMBODIMENTS

Hereinafter, embodiments of the present invention will be described with reference to the drawings and so on.

Imprint Apparatus

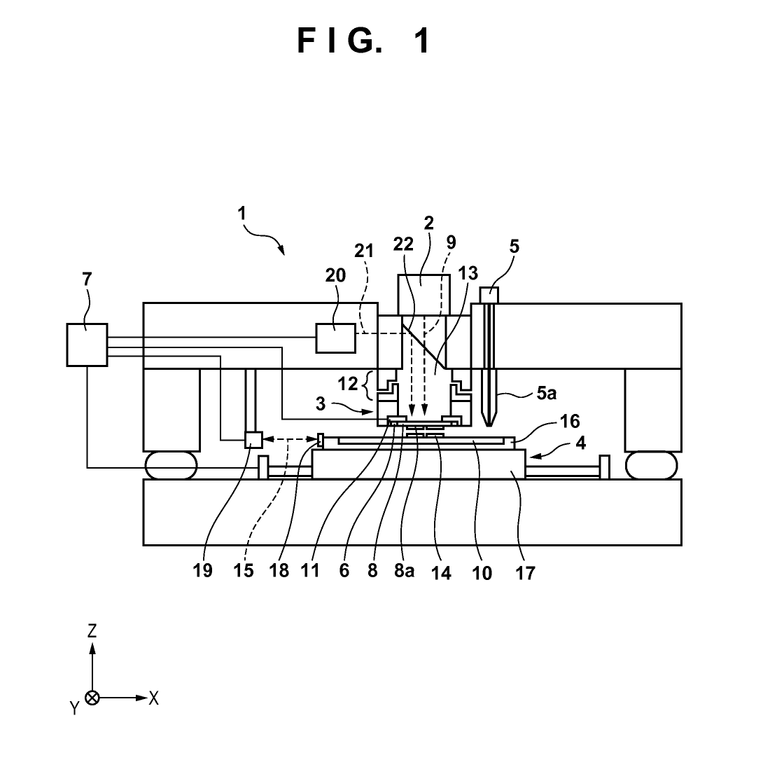

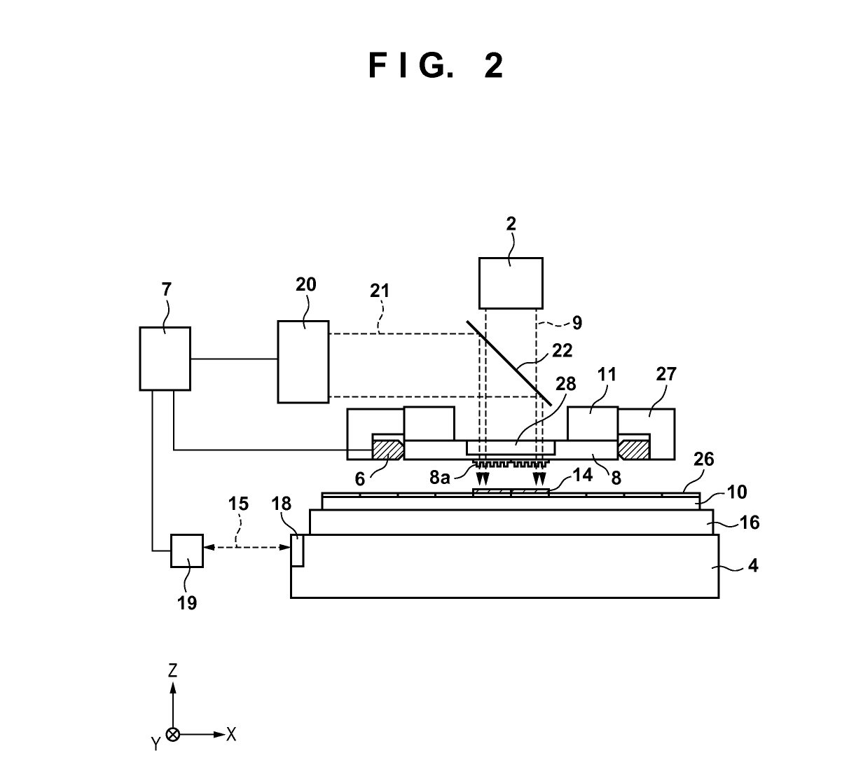

The configuration of an imprint apparatus according to the present invention, which is capable of simultaneously forming patterns in each of a plurality of imprint regions on a substrate, will be described using FIGS. 1 and 2. FIG. 1 illustrates the overall configuration of an imprint apparatus 1. FIG. 2 is an enlarged view of primary components illustrated in FIG. 1. The imprint apparatus 1 is used in the manufacture of articles such as semiconductor devices, and forms a resin pattern upon a substrate to be processed by forming uncured resin (an imprint material) upon the substrate using a mold. It is assumed here that the imprint apparatus employs a photo-curing method. Meanwhile, in FIGS. 1 and 2, a Z axis is set to be parallel to an optical axis of an irradiation unit that irradiates the resin on the substrate with ultraviolet light, and an X axis and a Y axis are set to be orthogonal to each other within a plane that is perpendicular to the Z axis. The imprint apparatus 1 includes an irradiation unit 2, a mold holding unit 3, a substrate stage 4, a coating unit (dispenser) 5, a correction unit 6 that corrects a shape of a pattern region in a mold 8, and a controller 7.

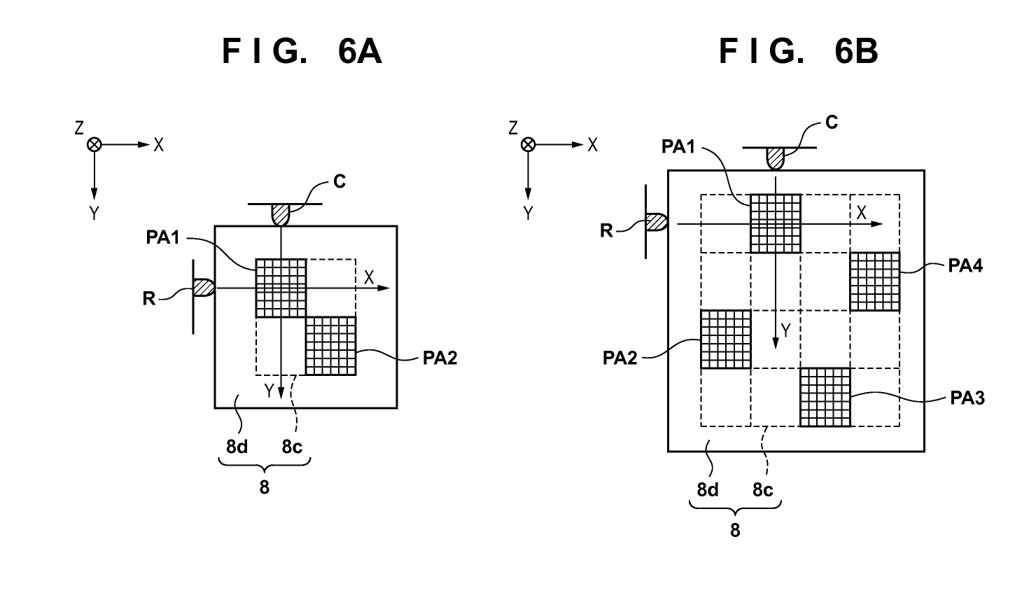

The irradiation unit 2 irradiates a resin 14 with ultraviolet light 9 during an imprint process. Although not shown here, the irradiation unit 2 includes a light source and an optical element that adjusts the ultraviolet light 9 emitted from the light source to light suitable for the imprint process. As illustrated in FIGS. 6A and 6B, the mold 8 has a quadrangular outer shape, and includes a peripheral region 8d located in the periphery of the mold 8 and a central region 8c surrounded by the peripheral region 8d. A cavity 28 is formed on a rear surface side of the central region 8c, which results in the central region 8c being thinner than the peripheral region 8d and makes the central region 8c easy to deform. The central region 8c includes a plurality of rectangular pattern regions PA having two sides parallel to an X direction (a first direction) and two sides parallel to a Y direction (a second direction).

As illustrated in FIG. 4, each pattern region PA includes a pattern portion 8a in which a pitted pattern for transferring a circuit pattern, for example, is formed three-dimensionally, and a scribe portion 8b that surrounds the pattern portion 8a and in which mold-side marks A are formed. The mold 8 is formed from a material that can transmit the ultraviolet light 9, and silica is used as an example in the present embodiment.

The mold holding unit 3 has a mold chuck 11 that holds the mold 8 and a mold drive unit 12 that moves the mold 8 while holding the mold chuck 11. The mold chuck 11 holds the mold 8 by attracting the peripheral region 8d of the mold 8 using the force of vacuum suction, static electricity, or the like. For example, in the case where the mold chuck 11 holds the mold 8 through vacuum suction, the mold chuck 11 is connected to a vacuum pump (not shown) disposed externally, and the mold 8 is attached and removed by switching the vacuum pump on and off. The mold chuck 11 and the mold drive unit 12 have an open region 13 in a central area (on an inner side thereof) so that the ultraviolet light 9 emitted from the irradiation unit 2 travels toward a substrate 10. A light-transmissive member (a glass plate, for example) that realizes the open region 13 as an airtight space is provided, and a pressure within the airtight space is adjusted by a pressure adjusting unit (not shown) that includes a vacuum pump and the like. For example, by setting the pressure within the airtight space to be greater than a pressure outside thereof, the pressure adjusting unit causes the central region 8c to flex in a convex shape toward the substrate 10, which can bring the central region 8c into contact with the resin 14 starting from a central area of the central region 8c when the mold 8 is pressed into the resin 14 on the substrate 10. Through this, gas (air) is suppressed from remaining in a space between the pattern portion 8a and the resin 14, and the resin 14 can be caused to fill the entirety of the space within the pattern portion 8a.

The mold drive unit 12 moves the mold 8 in the Z direction so as to selectively press (stamp) the mold 8 into the resin 14 on the substrate 10 (bring the mold into contact with the resin) or pull away (release) the mold 8. A linear motor or an air cylinder can be given as an example of an actuator that can be employed in the mold drive unit 12. The mold drive unit 12 may be constituted by a coarse moving driver and a fine moving driver in order to be capable of positioning the mold 8 with a high level of precision. Furthermore, the mold drive unit 12 may have a function for positional adjustment in the X direction, the Y direction, 0 directions in the respective axes, and so on in addition to the Z direction, a tilt function for correcting tilt in the mold 8, and so on. The pressing and releasing operations performed by the imprint apparatus 1 may be realized by moving the mold 8 in the Z direction, but may also be realized by moving the substrate stage 4 in the Z direction or by moving both the mold 8 and the substrate stage 4 relative to each other.

The substrate 10 is a single-crystal silicon substrate, an SOI (Silicon on Insulator) substrate, or the like, for example. A processing target surface of the substrate 10 is coated with the ultraviolet light-curable resin 14, which is shaped by the pattern portion 8a formed in the mold 8. An alignment measurement unit (detector) 20 irradiates the mold 8 and the substrate 10 with alignment light 21 and measures a deviation amount between the pattern regions PA formed in the mold 8 and an underlying pattern (an imprint region) 26 already formed in the substrate 10. The alignment light 21 uses a wavelength in a range from visible light to infrared light, and is reflected toward the mold 8 by a half mirror 22 that transmits the ultraviolet light 9, which serves as exposure light.

The substrate stage 4 holds the substrate 10, and positions the mold 8 and the resin 14 when the mold 8 is pressed into the resin 14 on the substrate 10. The substrate stage 4 has a substrate chuck 16 that holds the substrate 10 using an attraction force, and a stage drive unit 17 that holds the substrate chuck 16 mechanically and can move in the respective axial directions. A linear motor, a planar motor, or the like can be given as an example of an actuator that can be employed in the stage drive unit 17. The stage drive unit 17 may be constituted by a coarse moving driver and a fine moving driver for movement in both the X axis and Y axis directions. The stage drive unit 17 may also have a function for positional adjustment in the Z direction, positional adjustment in 0 directions of the substrate 10, or a tilt function for correcting tilt in the substrate 10. The substrate stage 4 includes, in a side face thereof, a plurality of reference mirrors 18 that correspond to each of X, Y, Z, cox, coy, and coz directions. The imprint apparatus 1 includes a plurality of laser interferometers 19 that measure the position of the substrate stage 4 by irradiating the reference mirrors 18 with respective laser beams 15. The laser interferometers 19 measure the position of the substrate stage 4 in real time, and the controller 7 executes positioning control and pattern shape control for the substrate 10 based on values measured at this time and the deviation amount of the patterns.

The coating unit 5 is disposed in the vicinity of the mold holding unit 3, and coats (supplies) the top of the substrate 10 with the uncured resin (imprint material) 14. Here, the resin 14 is a light curable resin (ultraviolet-curing resin) having a property of hardening when irradiated with the ultraviolet light 9, and is selected based on various types of conditions such as semiconductor device manufacturing processes and the like. Meanwhile, an amount of the resin 14 ejected from an ejection nozzle 5a of the coating unit 5 is determined based on a thickness of the resin 14 formed on the substrate 10, a density of the patterns to be formed, and so on. The correction unit 6 (a mold deforming mechanism) can correct the shape of the pattern portion 8a formed in the mold 8 by deforming the mold 8 in the X direction and the Y direction. For example, piezoelectric elements (pressing members) R and C that expand and contract due to changes in volume occurring when a voltage is applied thereto can be used in the correction unit 6, and these elements are disposed in a mold holding frame 27 so as to be capable of pressurizing the mold 8 at a plurality of locations in the side faces thereof. The mold holding frame 27 is formed as an integral part of the mold chuck 11.

### First Embodiment

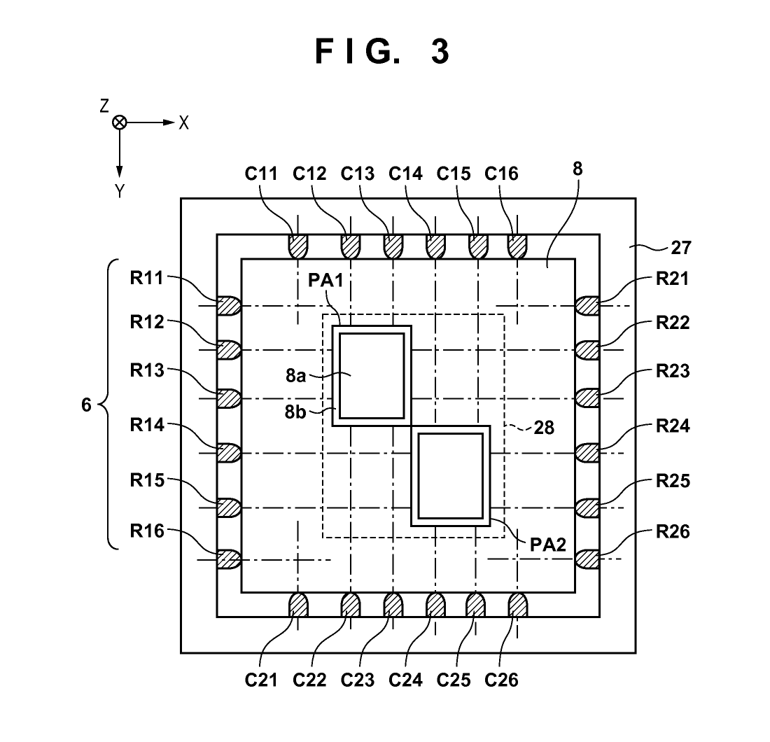

FIG. 3 is a diagram illustrating the mold 8 according to the first embodiment from a −Z direction. In the mold 8 according to the first embodiment, two pattern regions PA1 and PA2 are arranged in opposing corners. Piezoelectric elements (first pressing members) R that press corresponding side faces of the mold 8 in the X direction and piezoelectric elements (second pressing members) C that press corresponding side faces of the mold 8 in the Y direction in order to correct the shape of the pattern regions PA are disposed in the mold holding frame 27. A number of the piezoelectric elements R disposed at intervals in the Y direction so as to press in the X direction and a number of the piezoelectric elements C disposed at intervals in the X direction so as to press in the Y direction are determined based on a number and locations of pattern regions formed in the mold 8. In the first embodiment, the piezoelectric elements are disposed so that lines extending from at least two of the piezoelectric elements in the extension/contraction directions thereof (the dot-dash lines in FIG. 3) are contained within the respective sides of the pattern region. Through this, the correction unit 6 can carry out magnification correction, rotational correction, trapezoidal distortion correction, and parallelogram correction at an order of nanometers on the pattern regions PA1 and PA2, respectively. A relationship between a voltage applied and an extension/contraction amount is found for each piezoelectric element in advance, and the extension/contraction amounts are controlled by the controller 7. Meanwhile, the shape of the cavity 28 provided to make it easy for the pattern regions PA1 and PA2 to deform is not limited to a quadrangle, and a circle, a shape having the minimum possible size in which two pattern regions can fit, or the like may be used instead.

The mold 8 is attracted by the mold chuck 11 as described earlier, and reducing friction at the contact surface between the mold chuck 11 and the mold 8 can make it easy for the mold 8 to deform. However, if the attraction force of the mold chuck 11 is reduced in order to reduce the friction between the mold chuck 11 and the mold 8, the mold 8 may separate and fall from the mold chuck 11. Accordingly, friction between the mold 8 and contact surfaces of the piezoelectric element is set to be high, or the mold 8 is provided with a fall preventing member. Through this, the mold 8 can be deformed by the correction unit 6 without the mold 8 separating from the mold chuck 11 even if the attraction force of the mold chuck 11 is reduced.

In the case where the mold 8 is formed so that the pattern portions 8a are the same size as a design value, the piezoelectric elements will separate from the side faces of the mold 8 when the piezoelectric elements contract in order to increase the dimensions of the pattern regions, and the dimensions of the pattern regions cannot be increased. Accordingly, the pattern portions 8a are formed in the mold 8 so that, for example, the dimensions of the pattern regions take on the design value when the piezoelectric element is approximately half the length of a piezoelectric element extension/contraction stroke. As a result, the pattern regions can be both enlarged and reduced relative to the design value by the piezoelectric elements.

The controller 7 obtains the deviation amount between the shapes of the pattern region and the imprint region based on a detection result from the alignment measurement unit 20. In the case where the controller 7 has determined that the obtained deviation amount exceeds an allowable range, the controller 7 determines a driving amount for the substrate stage 4 and an extension/contraction amount for each piezoelectric element, and then controls the stage drive unit 17 and the correction unit 6, so as to reduce the deviation amount. An example of a control method carried out by the controller 7 will be described in detail below. FIG. 4 is a diagram illustrating the pattern regions PA1 and PA2 and representative piezoelectric elements R11 and C11 from FIG. 3 in an enlarged state. A total of eight marks (alignment marks) A111 to A142 are provided, two to a side, in an outer peripheral area of the pattern region PA1. Likewise, eight marks A211 to A242 are provided for the pattern region PA2 as well. The number of marks is determined based on the intended corrected shape, and a greater number of marks is necessary in the case where higher-level shape correction is necessary, as with bow-shaped correction, barrel-shaped correction, and so on.

First, a movement amount for each mark relative to a unit driving amount of the respective piezoelectric elements is found through measurement or simulation, as preparation for controlling the shape of the pattern. For example, it is assumed that the movement amount of each mark in the X direction is X(R11)A111, X(R11)A112, and so on up to X(R11)A242 when the side face of the mold 8 is pressed 1 μm by the piezoelectric element R11. Likewise, it is assumed that a movement amount in the Y direction is Y(R11)A111, Y(R11)A112, and so on up to Y(R11)A242. The movement amounts for the marks are found in the same manner for the other piezoelectric elements as well.

At this time, an X direction movement amount X(A111) of the mark A111 when a stroke s (“piezoelectric element name”) is imparted by the corresponding piezoelectric element can be expressed as indicated by Formula 1.

X(A111)=S(R11)*X(R11)A111+S(R12)*X(R12)A111+ . . . +S(R16)*X(R16)A111+S(R21)*X(R21)A111+S(R22)*X(R22)A111+ . . . +S(R26)*X(R26)A111+S(C11)*X(C11)A111+S(C12)*X(C12)A111+ . . . +S(RC16)*X(C16)A111+S(C21)*X(C21)A111+S(C22)*X(C22)A111+ . . . +S(RC26)*X(C26)A111 (1)

Likewise, a Y direction movement amount Y(A111) can be expressed as indicated in Formula 2.

Y(A111)=S(R11)*Y(R11)A111+S(R12)*Y(R12)A111+ . . . +S(R16)*Y(R16)A111+S(R21)*Y(R21)A111+S(R22)*Y(R22)A111+ . . . +S(R26)*Y(R26)A111+S(C11)*Y(C11)A111+S(C12)*Y(C12)A111+ . . . +S(RC16)*Y(C16)A111+S(C21)*Y(C21)A111+S(C22)*Y(C22)A111+ . . . +S(RC26)*Y(C26)A111 (2)

Ultimately, all of the movement amounts of the marks are expressed as driving amounts for the respective piezoelectric elements, and those driving amounts are consolidated and prepared as a correction table.

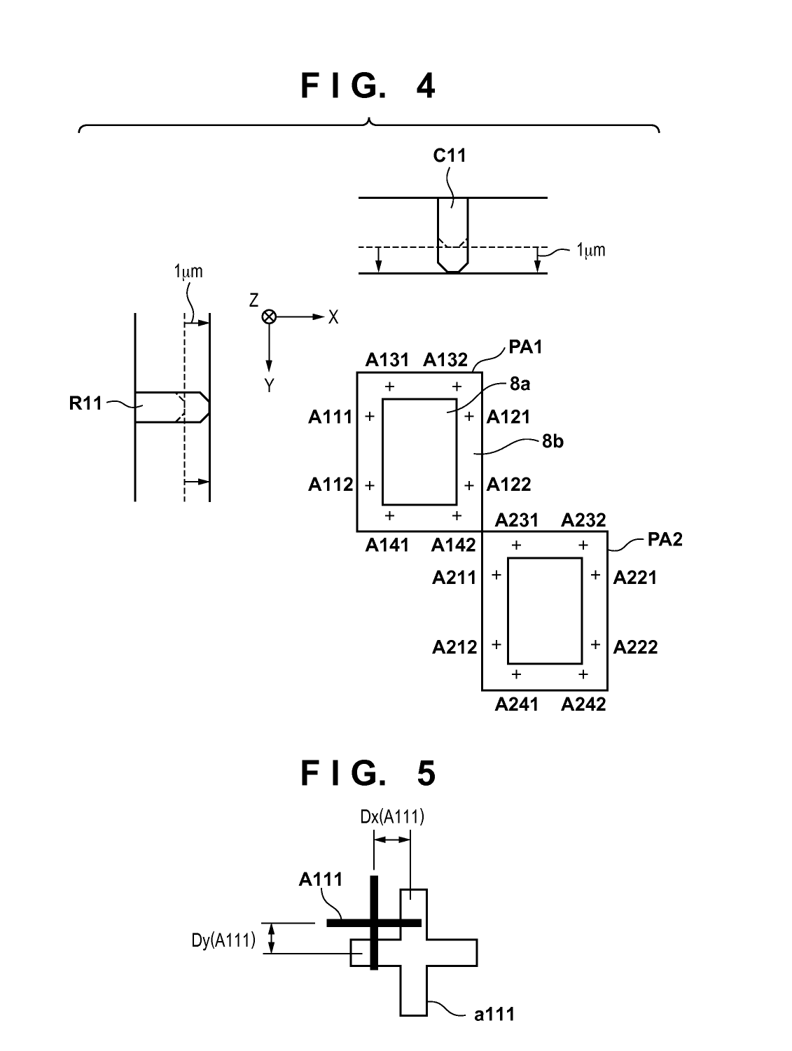

Next, deviation amounts between mold-side marks and substrate-side marks are measured by the alignment measurement unit 20, using the substrate-side marks as a reference. FIG. 5 illustrates the measurement of a deviation amount between a mold-side mark A111 and a substrate-side mark a111. In the example illustrated in FIG. 5, a measurement result indicating that the mark A111 deviates from the mark a111 by Dx(A111) in the X direction and Dy(A111) in the Y direction is sent to the controller 7 by the alignment measurement unit 20. The deviation amounts for the other marks are measured and sent to the controller 7 in the same manner.

Next, the controller 7 calculates an amount of correction through movement and rotation of the substrate stage 4 from the deviation amounts for the respective marks (Dx(A111), Dy(A111)), (Dx(A112), Dy(A112)), and so on up to (Dx(A242), Dy(A242)), and carries out correction. At this time, the calculated movement amount and rotation amount of the substrate stage 4 is sent to the stage drive unit 17 from the controller 7 as a command value, and the stage drive unit 17 then drives the substrate stage 4. The deviation amounts for the respective marks become (dx(A111), dy(A111)), (dx(A112), dy(A112)), and so on up to (dx(A242), dy(A242)) after the correction. Normally, the post-correction deviation amounts for the respective marks will not be zero due to the underlying pattern on the substrate 10 that has undergone the pattern forming process having deformed from the design values, and thus the deviation amounts are corrected by the correction unit 6.

Next, using the correction table, the controller 7 calculates a stroke amount for each piezoelectric element at which a sum of squares ΣRes2 of post-correction residue is minimum, as indicated in the following Formula 3. It is necessary for the post-correction residue to be within a pattern overlay error specification.

ΣRes2=(dx(A111)−x(A111))2+(dy(A111)−y(A111))2+(dx(A112)−x(A112))2+(dy(A112)−y(A112))2+ . . . +(dx(A242)−x(A242))2+(dy(A242)−y(A242))2 (3)

The calculated stroke amounts s(R11) to s(R16), s(R21) to s(R26), s(C11) to s(C16), and s(C21) to s(C26) for the respective piezoelectric elements are sent to the correction unit 6 from the controller 7 as command values. The correction unit 6 drives the respective piezoelectric elements based on the command values that have been sent, and corrects the shapes of the pattern regions PA1 and PA2.

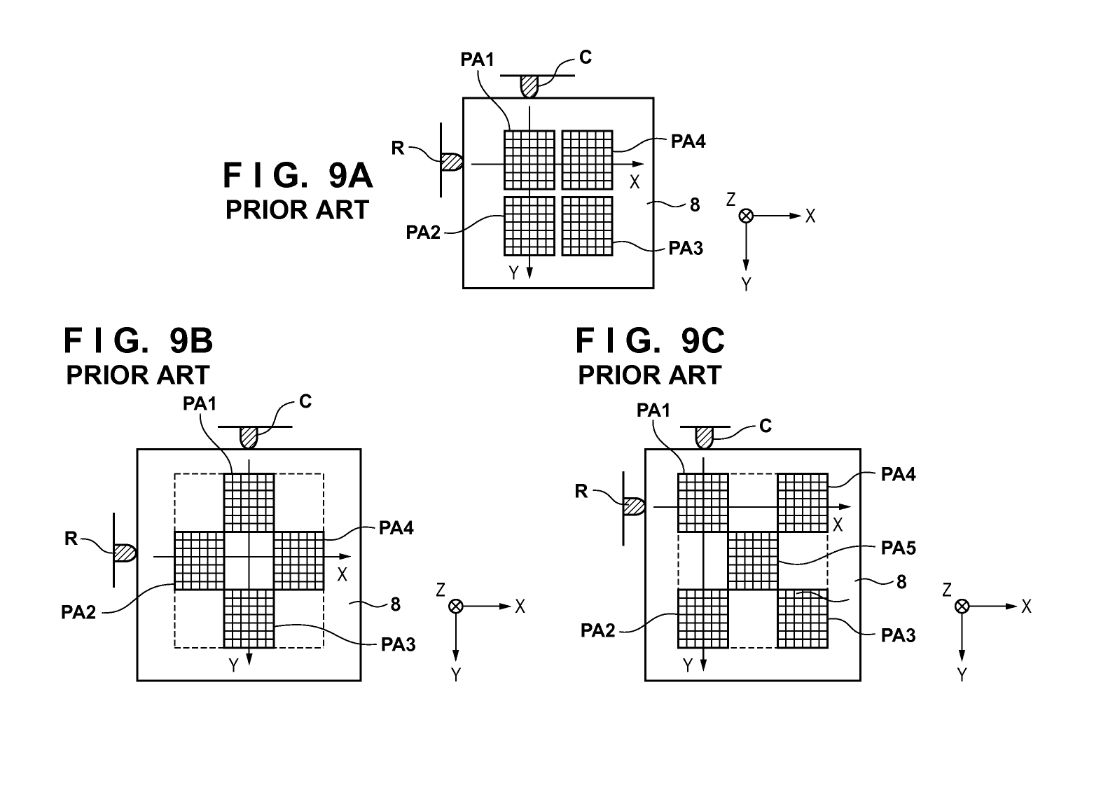

In order to reduce the sum of squares ΣRes2 of the correction residue of the shapes of a plurality of pattern regions, it is necessary to individually reduce pattern shape correction residue in each item on the right side of Formula 3. As can be seen from Formula 1 and Formula 2, the movement amounts of the marks are dependent on the extension/contraction of the respective piezoelectric elements. Accordingly, in order to move each mark individually, it is desirable for a single alignment mark to move dominantly in response to the driving of a single piezoelectric element. With the arrangement of the pattern regions in the related art illustrated in FIG. 9, a plurality of pattern regions are contained within extension lines in the extension/contraction directions of the piezoelectric elements R or the piezoelectric elements C. In this case, it has been possible for the marks moving dependently in response to the driving of a single piezoelectric element to span a plurality of pattern regions, making it impossible to sufficiently reduce the stated individual pattern shape correction residue.

FIGS. 6A and 6B illustrate examples of the mold 8 in which a plurality of pattern regions are formed, according to the first embodiment. FIG. 6A illustrates a case where there are two pattern regions, and FIG. 6B illustrates a case where there are four pattern regions. Although FIG. 6A illustrates the two pattern regions PA1 and PA2 as being in contact with each other, it should be noted that a scribe line (not shown), approximately 100 μm wide, is provided in the outer peripheral area of the two pattern regions PA1 and PA2. Accordingly, the pattern portions formed in the pattern regions PA1 and PA2 do not make contact with each other, and thus displacement on the nm order is possible between the pattern portions.

The mold 8 according to the first embodiment sets no greater than one pattern region to be located in each row and each column for pattern regions obtained by dividing the pattern plane into rows and columns. A region sandwiched between two straight lines obtained by extending, in the X direction, two sides of the one pattern region PA1 that are each parallel to the X direction is taken as a first region, and a region sandwiched between two straight lines obtained by extending, in the Y direction, two sides of the one pattern region PA1 that are each parallel to the Y direction is taken as a second region. At this time, the pattern regions are arranged so that the other pattern region PA2 and so on are present in regions in the central region 8c aside from the first region and the second region. Thus the other pattern region PA2 and so on are not located in the first region and the second region in which the one pattern region PA1 is located. Accordingly, no greater than one pattern region is present on the lines extending in the extension/contraction direction of the piezoelectric elements R or the piezoelectric elements C, and thus the mark that moves dominantly in response to the driving of a single piezoelectric element does not span a plurality of pattern regions. As a result, according to the imprint apparatus using the mold 8 of the first embodiment, it is easy to individually reduce the pattern correction residue at each mark location, and thus the aforementioned sum of squares ΣRes2 of the pattern correction residue can be further reduced.

The method of correcting the shape of the mold pattern that reduces the deviation amount among individual marks is merely an example, and is not limited to that described here. For example, there is also a correction method that determines a stroke amount for each piezoelectric element based on a result of calculating a shape to be corrected for a single pattern region as a whole from the deviation amount of each mark as a sum of magnification, trapezoid, and rotation components.

### Second Embodiment

A mold 8 according to a second embodiment will be described next. In the first embodiment, the shapes that can be corrected on the mold 8 side relative to the shape of the underlying pattern formed in advance in the substrate 10 correspond to shift, magnification, rotation, trapezoid, bow, and barrel components among others, and thus there is a comparatively high level of freedom. However, during correction, there is a large degree of interference among the respective shape correction components, and thus even if the correction can be carried out so as to minimize the correction residue while employing all of the components, it is difficult to correct only a specific shape component with a high level of precision. Depending on the semiconductor process, there are cases where the patterns formed in the substrate 10 are to be corrected individually for only simple shift and rotation error, at a particularly high level of precision. In such a case, the pattern correction residue can be effectively reduced even more by employing a configuration in which only specific shapes are corrected on the mold side.

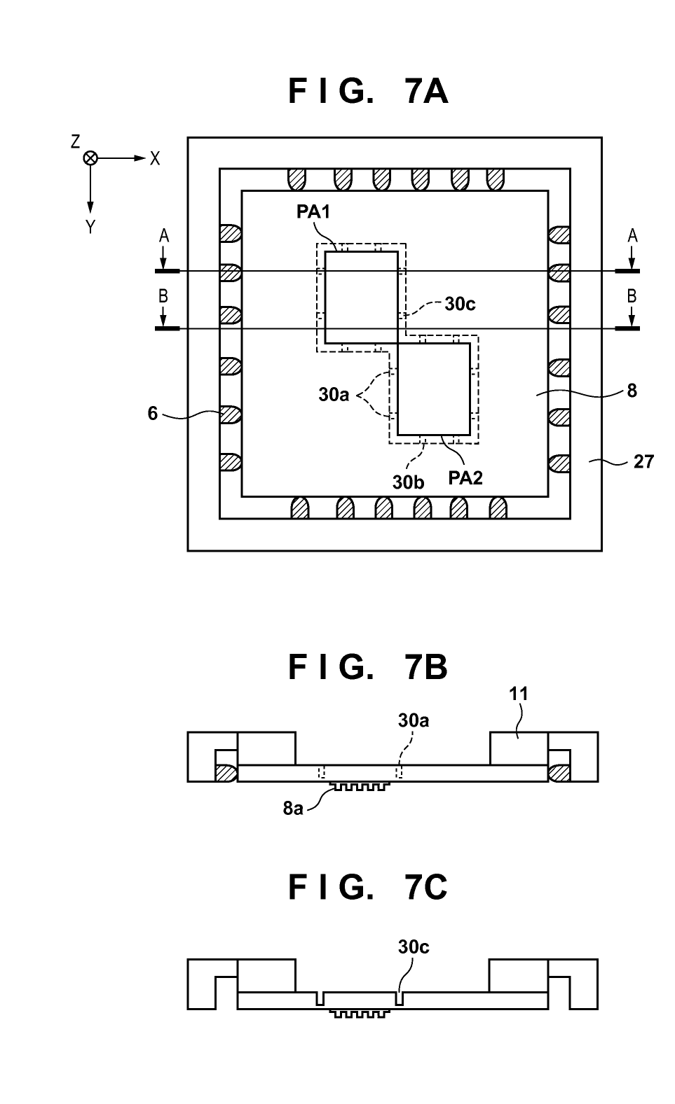

FIGS. 7A to 7C illustrate a configuration that makes shift correction and rotational correction of the pattern regions particularly easy in order to overlay the mold 8 on the underlying pattern formed in the substrate 10. FIG. 7A is a diagram illustrating the mold 8 from a pattern surface. FIG. 7B is a cross-sectional view along the A-A illustrated in FIG. 7A, and FIG. 7C is a cross-sectional view along the B-B illustrated in FIG. 7A. In the mold 8 according to the second embodiment, grooves (a third connecting portion) 29 are formed, leaving a connecting portion (a first connecting portion) 30a, extending in the X direction, in two locations on each side in the periphery of the pattern regions PA1 and PA2, and a connecting portion (a second connecting portion) 30b, extending in the Y direction, in two locations on each side in the periphery of the pattern regions PA1 and PA2. The grooves 29 may pass through the mold 8, or may avoiding passing through the mold 8, as indicated in FIG. 7C.

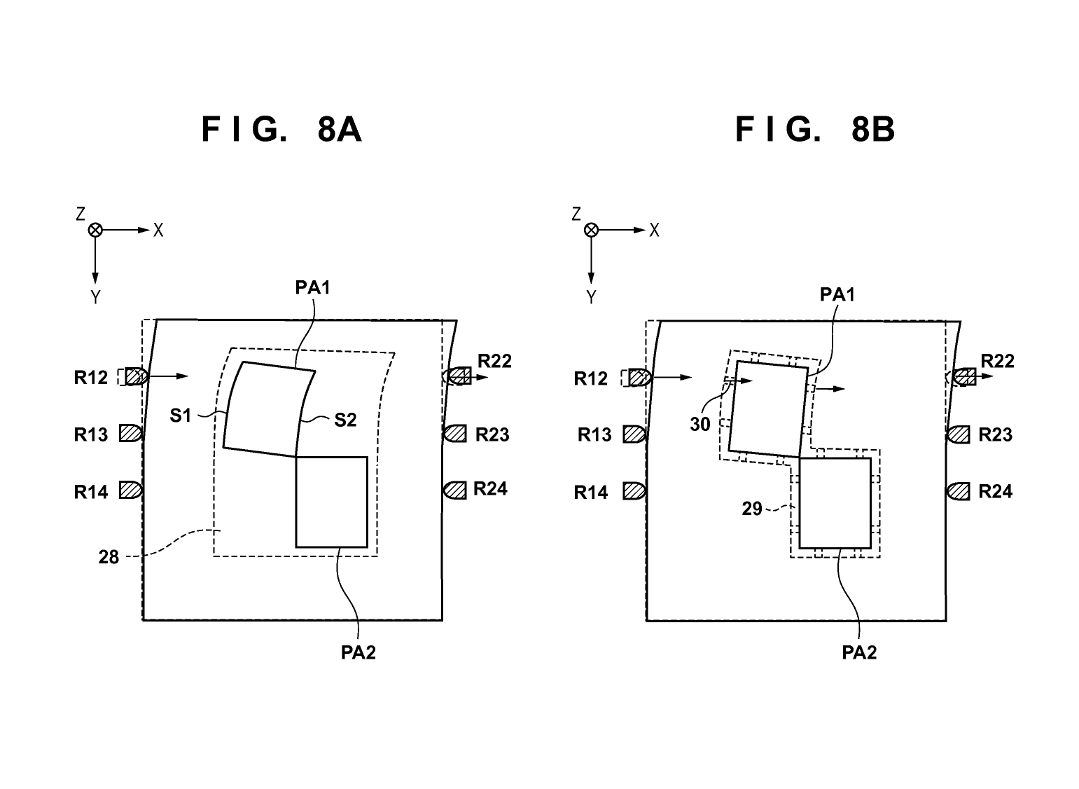

FIGS. 8A and 8B illustrate a case where the pattern portion 8a formed in the pattern region PA1 undergoes rotational correction. FIG. 8A illustrates a case where a mold that does not have the grooves 29 formed in the periphery of the pattern regions PA1 and PA2 is used. FIG. 8B illustrates a case where the mold according to the second embodiment, in which the grooves 29 are formed in the periphery of the pattern regions PA1 and PA2, is used. In the case of FIG. 8A, even if the piezoelectric elements R12 and R22 are displaced in an attempt to correct only the rotation of the pattern portion 8a in the pattern region PA1, a bow component will be produced due to distributed force being transmitted to sides S1 and S2 of the pattern region PA1. On the other hand, in the case of FIG. 8B, as a result of the grooves 29 being provided in the periphery of the pattern region PA1, the force produced by the displacement of the piezoelectric elements R12 and R22 is transmitted only through the connecting portions 30. Accordingly, the rotation component of the pattern portion 8a can be corrected with a higher level of precision as compared to the case illustrated in FIG. 8A.

Article Manufacturing Method

An article manufacturing method for a device (a semiconductor integrated circuit element, a liquid crystal display element, or the like) or the like includes a process of forming a pattern on a substrate (a wafer, a glass plate, a film-type substrate) using the aforementioned imprint apparatus. The manufacturing method can further include a process of etching the substrate on which the pattern has been formed. Note that in the case of manufacturing another article such as patterned media (a recording medium), an optical element, or the like, the manufacturing method can include other processes of working the substrate on which the pattern has been formed instead of the etching. The article manufacturing method according to the present embodiment is more useful than conventional methods in at least one of the performance, quality, productivity, and production cost of the article.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-146294, filed Jul. 16, 2014, which is hereby incorporated by reference herein in its entirety.

What is claimed is:

1. A mold capable of simultaneously forming a plurality of patterns of an imprint material on a substrate, the mold including:
a plurality of pattern regions, each having two sides parallel to a first direction and two sides parallel to a second direction,
wherein the plurality of pattern regions are located so that, for each of the plurality of pattern regions, the other pattern regions are present in regions of the mold aside from a first region sandwiched between two straight lines formed by extending the two sides parallel to the first direction in the first direction and a second region sandwiched between two straight lines formed by extending the two sides parallel to the second direction in the second direction.

2. The mold according to claim 1,
wherein the plurality of pattern regions each having a pattern portion in which the pattern is formed and a scribe portion that surrounds the pattern portion.

3. The mold according to claim 1,
wherein the mold includes a peripheral region located in a periphery of the mold and a central region surrounded by the peripheral region and having thickness smaller than the peripheral region; and
the plurality of pattern regions are located in the central region.

4. The mold according to claim 1,
wherein each of the plurality of pattern regions is connected to each of four regions, corresponding to two regions sandwiching the pattern region in the first region and two regions sandwiching the pattern region in the second region, via connecting portions.

5. The mold according to claim 4,
wherein the connecting portions include at least two first connecting portions, located at intervals from each other in the second direction, that connect to the two regions in the first region that sandwich the pattern region, and at least two second connecting portions, located at intervals from each other in the first direction, that connect to the two regions in the second region that sandwich the pattern region.

6. The mold according to claim 5,
wherein the connecting portions further include a third connecting portion having thickness smaller than the first connecting portions and the second connecting portions.

7. An imprint apparatus for simultaneously forming patterns of an imprint material in each of a plurality of imprint regions on a substrate by using a mold,
wherein the mold includes a plurality of pattern regions, each having two sides parallel to a first direction and two sides parallel to a second direction;
the plurality of pattern regions are located so that, for each of the plurality of pattern regions, the other pattern regions are not present in either of a first region of the mold that is sandwiched between two straight lines formed by extending the two sides parallel to the first direction in the first direction and a second region of the mold that is sandwiched between two straight lines formed by extending the two sides parallel to the second direction in the second direction; and
the imprint apparatus comprises:
at least two first pressing members configured to each press a side face of the first region of the mold with an interval in the second direction and at least two second pressing members configured to each press a side face of the second region of the mold with an interval in the first direction, for each of the plurality of pattern regions; and
a controller that, for each of the plurality of pattern regions, configured to obtain a deviation amount from a shape of an imprint region corresponding to the pattern region, and drive at least one of the at least two first pressing members and the at least two second pressing members that exerts a force on a pattern region in which the obtained deviation amount exceeds an allowable range so as to reduce the deviation amount.

8. The imprint apparatus according to claim 7,
wherein each of the plurality of pattern regions is connected to the two regions in the first region that sandwich the pattern region by at least two first connecting portions located at intervals from each other in the second direction;
each of the plurality of pattern regions is connected to the two regions in the second region that sandwich the pattern region by at least two second connecting portions located at intervals from each other in the first direction;
each of the at least two first pressing members presses a side face of the mold at a location, in the second direction, where a corresponding one of the at least two first connecting portions is located; and
each of the at least two second pressing members presses a side face of the mold at a location, in the first direction, where a corresponding one of the at least two second connecting portions is located.

9. The imprint apparatus according to claim 7, further comprising:
a detector configured to detect a mold-side mark located in the scribe portion of each of the plurality of pattern regions and a substrate-side mark located in each of the plurality of imprint regions,
wherein the controller configured to obtain the deviation amount from a detection result from the detector.

10. A method of manufacturing an article, the method comprising:
forming a pattern on a substrate using an imprint apparatus; and
processing the substrate on which the pattern has been formed, to manufacture the article,
wherein the imprint apparatus is configured to simultaneously form patterns of an imprint material in each of a plurality of imprint regions on the substrate;
the mold includes a plurality of pattern regions, each having two sides parallel to a first direction and two sides parallel to a second direction perpendicular to the first direction;
the plurality of pattern regions are located so that, for each of the plurality of pattern regions, the other pattern regions are not present in either of a first region of the mold that is sandwiched between two straight lines formed by extending the two sides parallel to the first direction in the first direction and a second region of the mold that is sandwiched between two straight lines formed by extending the two sides parallel to the second direction in the second direction; and
the imprint apparatus includes:
at least two first pressing members configured to each press a side face of the first region of the mold with an interval in the second direction and at least two second pressing members configured to each press a side face of the second region of the mold with an interval in the first direction, for each of the plurality of pattern regions; and
a controller that, for each of the plurality of pattern regions, configured to obtain a deviation amount from a shape of an imprint region corresponding to the pattern region, and drive at least one of the at least two first pressing members and the at least two second pressing members that exerts a force on a pattern region in which the obtained deviation amount exceeds an allowable range so as to reduce the deviation amount.

11. A mold capable of simultaneously forming a plurality of patterns of an imprint material on a substrate, the mold including:
a plurality of pattern regions, each having two sides along a first direction and two sides along a second direction,
wherein the plurality of pattern regions are located so that, for at least one of the plurality of pattern regions, the other pattern regions are present in regions of the mold aside from a first region sandwiched between two lines formed by extending the two sides along the first direction in the first direction and a second region sandwiched between two lines formed by extending the two sides along the second direction in the second direction.

12. An imprint apparatus for simultaneously forming patterns of an imprint material in each of a plurality of imprint regions on a substrate by using a mold,
wherein the mold includes a plurality of pattern regions, each having two sides along a first direction and two sides along a second direction, and
wherein the plurality of pattern regions are located so that, for at least one of the plurality of pattern regions, the other pattern regions are present in regions of the mold aside from a first region sandwiched between two lines formed by extending the two sides along the first direction in the first direction and a second region sandwiched between two lines formed by extending the two sides along the second direction in the second direction.
